(19) United States
(12) Patent Application Publication
(10) Pub. No.: US 2026/0062060 A1
(43) Pub. Date: Mar. 5, 2026

(54) VEHICLE SIDE SILL STRUCTURE

(71) Applicants: Hyundai Motor Company, Seoul (KR); Kia Corporation, Seoul (KR)

(72) Inventors: Min Cheol Kim, Hwaseong-si (KR); Tae Yeong Kim, Hwaseong-si (KR)

(21) Appl. No.: 18/966,292

(22) Filed: Dec. 3, 2024

(30) Foreign Application Priority Data
Aug. 29, 2024 (KR) 10-2024-0116971

(51) Int. Cl. B62D 25/02; B60K 1/04; B62D 21/15

(52) U.S. Cl. CPC B62D 25/025; B60K 1/04; B62D 21/157; B60K 2001/0438

(57) ABSTRACT

A vehicle side sill structure can include an inner side sill fixed to a floor of a vehicle, an outer side sill joined to the inner side sill, and a first reinforcement and a second reinforcement disposed in a cavity defined between the inner side sill and the outer side sill, where the first reinforcement is fixed to the inner side sill, and the second reinforcement is fixed to the outer side sill.

### CROSS-REFERENCE TO RELATED APPLICATIONS

This application is based on and claims the benefit of priority to Korean Patent Application No. 10-2024-0116971, filed on Aug. 29, 2024, in the Korean Intellectual Property Office, the disclosure of which is incorporated herein in its entirety by reference.

### TECHNICAL FIELD

The present disclosure relates to a vehicle side sill structure.

### BACKGROUND

In recent years, as the perception of environmental crisis and depletion of oil resources has increased, research and development (R&D) on electric vehicles (EVs), which are eco-friendly vehicles, is being actively conducted. The EVs may include a plug-in hybrid electric vehicle (PHEV), a battery electric vehicle (BEV), and a fuel cell electric vehicle (FCEV).

The EV may have a high-voltage battery assembly mounted on a vehicle body, and the high-voltage battery assembly may include one or more battery cells (or battery module), electric/electronic components related to the battery cells, a battery case in which the battery cells and the electric/electronic components are mounted, and a cover covering the top of the battery case. The battery case may have a plurality of crossmembers fixed therein so that stiffness and strength of the battery case may be improved by the plurality of crossmembers. The high-voltage battery assembly may be mounted below a floor panel of the vehicle body.

A side sill structure may be provided at both side edges of the floor panel. The side sill structure may include a pair of side sills fixed to both side edges of the floor panel, and a pair of side sill reinforcements disposed in the pair of side sills, respectively. Each side sill may include an inner side sill and an outer side sill. The inner side sill and the outer side sill may be made of a steel material, and each side sill reinforcement may be made of an aluminum extruded product. A pair of side mounts may be provided on both sides of the battery case, and each side mount and each side sill may be joined through a bolt, a cylindrical nut (pipe nut), and/or the like so that the high-voltage battery assembly may be mounted on each side sill.

In the side sill structure according to the related art, however, the side sill reinforcement may be excessively deformed by impact energy in the event of a side collision/impact of the vehicle, and accordingly the battery assembly may be excessively damaged. In particular, because the side sill reinforcement does not sufficiently absorb the impact energy, the vehicle body cannot sufficiently support an impact load, resulting in severe damage to the vehicle body and the battery assembly.

In addition, because the side sill reinforcement in the related art side sill structure is made of the aluminum extruded product, the manufacturing cost and weight thereof may relatively increase. As a result, the weight of the vehicle increases, leading to reduction in all electric range (AER) of the EV.

The above information described in this background section is provided to assist in understanding the background of the present disclosure, and may include information that is not considered as the prior art that is already publicly known, available, or in use.

### SUMMARY

The present disclosure relates to a vehicle side sill structure, and more particularly, to a vehicle side sill structure designed to sufficiently absorb impact energy in the event of a side collision/impact of a vehicle, thereby safely protecting a battery assembly and significantly reducing deformation of a vehicle body.

An embodiment of the present disclosure can solve the above-mentioned problems occurring in the prior art while advantages achieved by the prior art are maintained intact.

An embodiment of the present disclosure can provide a vehicle side sill structure designed to sufficiently absorb impact energy in the event of a side collision/impact of a vehicle, thereby safely protecting a battery assembly and significantly reducing deformation of a vehicle body.

According to an embodiment of the present disclosure, a vehicle side sill structure may include: an inner side sill fixed to a floor of a vehicle; an outer side sill joined to the inner side sill; and a first reinforcement and a second reinforcement disposed in a cavity defined between the inner side sill and the outer side sill. The first reinforcement may be fixed to the inner side sill, and the second reinforcement may be fixed to the outer side sill.

The second reinforcement may be fixed to the first reinforcement.

The first reinforcement may have a rectangular frame shape cross section.

The first reinforcement may include a top wall facing the top of the vehicle, and a bottom wall facing the bottom of the vehicle, and the top wall and the bottom wall may extend horizontally from the inner side sill toward the outer side sill.

The first reinforcement may further include an intermediate wall extending horizontally between the top wall and the bottom wall.

The first reinforcement may include an upper inner wall and a lower inner wall facing the interior of the vehicle, and an upper outer wall and a lower outer wall facing the exterior of the vehicle. A bottom edge of the upper inner wall may be overlapped with and fixed to a top edge of the lower inner wall, and a bottom edge of the upper outer wall may be overlapped with and fixed to a top edge of the lower outer wall.

The second reinforcement may have a trapezoidal frame shape cross section.

The second reinforcement may include an outer wall facing the exterior of the vehicle, an inner wall facing the interior of the vehicle, a top wall extending from a top edge of the outer wall to a top edge of the inner wall, and a bottom wall extending from a bottom edge of the outer wall to a bottom edge of the inner wall.

The top wall may be inclined downward from the top edge of the inner wall toward the top edge of the outer wall, and the bottom wall may be inclined upward from the bottom edge of the inner wall toward the bottom edge of the outer wall.

The second reinforcement may further include a recessed wall that is recessed from the inner wall toward the outer wall.

The first reinforcement may include an intermediate wall located between a top wall and a bottom wall thereof, and the intermediate wall of the first reinforcement may be aligned with the recessed wall of the second reinforcement.

The top wall of the second reinforcement may be located lower than the top wall of the first reinforcement, and the bottom wall of the second reinforcement may be located higher than the bottom wall of the first reinforcement.

The vehicle side sill structure may further include a support bracket configured to support the first reinforcement and the second reinforcement.

The support bracket may have a top flange fixed to the first reinforcement.

A cross-sectional area of the first reinforcement may be larger than a cross-sectional area of the second reinforcement.

### BRIEF DESCRIPTION OF THE DRAWINGS

The above and other features and advantages of an embodiment of the present disclosure can be more apparent from the following detailed description taken in conjunction with the accompanying drawings, in which:

FIG. 1 illustrates a cross-sectional view of a vehicle side sill structure according to an example embodiment of the present disclosure;

FIG. 2 illustrates a perspective view of a first reinforcement, a second reinforcement, and support brackets in a vehicle side sill structure according to an example embodiment of the present disclosure; and

FIG. 3 illustrates a cross-sectional view of a state in which a first reinforcement, a second reinforcement, and a support bracket can be connected in a vehicle side sill structure according to an example embodiment of the present disclosure.

### DETAILED DESCRIPTION OF ILLUSTRATIVE EMBODIMENTS

Hereinafter, example embodiments of the present disclosure will be described in detail with reference to the accompanying drawings. In the drawings, same reference numerals can be used throughout to designate same or equivalent elements. A detailed description of well-known techniques associated with embodiments of the present disclosure can be ruled out to not unnecessarily obscure the gist of the present disclosure.

Terms such as “first,” “second,” “A,” “B,” “(a),” and “(b)” may be used to describe the elements in example embodiments of the present disclosure. These terms can be used merely to distinguish one element from another element, and the intrinsic features, sequence or order, and the like of the corresponding elements are not necessarily limited by these terms. Unless otherwise defined, terms used herein, including technical or scientific terms, can have a same meanings as those generally understood by those with ordinary knowledge in the field of art to which the present disclosure belongs. Such terms as those defined in a generally used dictionary can be interpreted in the context of meanings in the relevant field of art.

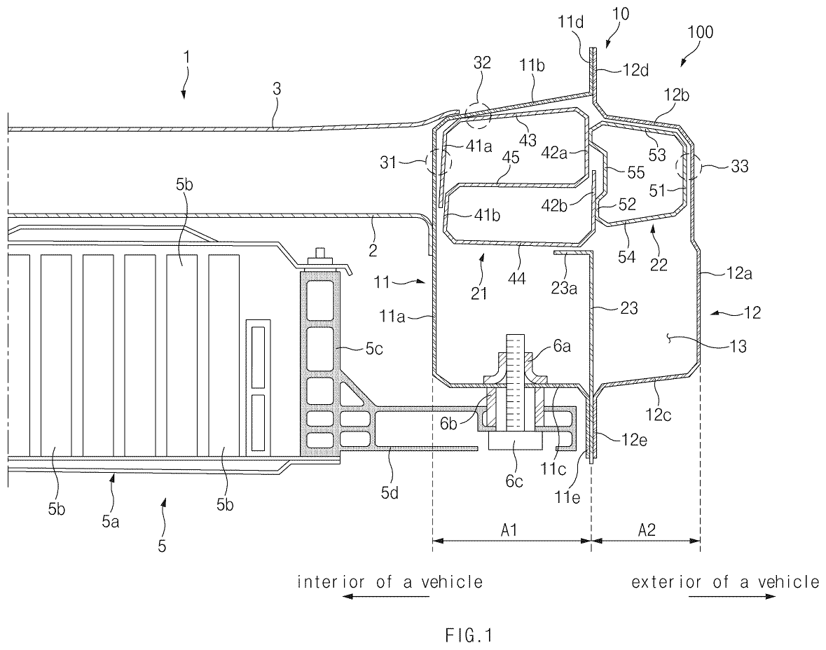

Referring to FIG. 1, a vehicle side sill structure 100, according to example embodiments of the present disclosure, may include a side sill 10 mounted at an edge of a floor 2 of a vehicle body 1, and a first reinforcement 21 and a second reinforcement 22 disposed in the side sill 10.

Each side sill 10 may include an inner side sill 11 facing the interior of the vehicle, and an outer side sill 12 facing the exterior of the vehicle. The inner side sill 11 may be fixed to the edge of the floor 2, and the outer side sill 12 may be joined to the inner side sill 11.

Referring to FIG. 1, a plurality of seat crossmembers 3 may be fixed to a top surface of the floor 2, and each seat crossmember 3 may extend in a width direction of the vehicle. The plurality of seat crossmembers 3 may be spaced apart from each other in a longitudinal direction of the vehicle, and seat mounts for a vehicle seat may be mounted on the plurality of seat crossmembers 3.

Referring to FIG. 1, a battery assembly 5 may be disposed below the floor 2 of the vehicle body 1, and the battery assembly 5 may include a battery case 5a, and a plurality of battery cells 5b mounted in the battery case 5a. Electric/electronic components connected to the plurality of battery cells 5b may be disposed in the battery case 5a. The battery case 5a may include a side mount 5d horizontally extending from a sidewall 5c toward the exterior of the vehicle. The side mount 5d of the battery case 5a may be fixed to a bottom surface of the side sill 10 through a nut 6a, a mounting pipe 6b, and a bolt 6c. The nut 6a may be fixed to the inside of the side sill 10, and the mounting pipe 6b may be aligned with the nut 6a. The mounting pipe 6b may be fixed to the side mount 5d, and the bolt 6c may extend through the mounting pipe 6b and be screwed into the nut 6a. The battery case 5a may be spaced apart from the side sill 10 toward the interior of the vehicle through the side mount 5d by a predetermined distance.

Although not shown, the pair of side sills 10 may be mounted at both side edges of the floor 2, respectively, and each side sill 10 may extend in the longitudinal direction of the vehicle.

Referring to FIG. 1, the inner side sill 11 may have a cavity which is open to the exterior of the vehicle, and the outer side sill 12 may have a cavity which is open to the interior of the vehicle. The inner side sill 11 and the outer side sill 12 may be joined so that the inner side sill 11 and the outer side sill 12 may define a cavity 13.

Referring to FIG. 1, the inner side sill 11 may include an inner wall 11a facing the interior of the vehicle, a top wall 11b facing the top of the vehicle, and a bottom wall 11c facing the bottom of the vehicle. The inner wall 11a may extend vertically, and the side edge of the floor 2 may be fixed to the inner wall 11a using fasteners, welding, and/or the like. The top wall 11b may extend horizontally from a top edge of the inner wall 11a toward the exterior of the vehicle, and a top flange 11d may extend vertically upwards from an outer edge of the top wall 11b. The bottom wall 11c may extend horizontally from a bottom edge of the inner wall 11a toward the exterior of the vehicle, and a bottom flange 11e may extend vertically downwards from an outer edge of the bottom wall 11c.

Referring to FIG. 1, the outer side sill 12 may include an outer wall 12a facing the exterior of the vehicle, a top wall 12b facing the top of the vehicle, and a bottom wall 12c facing the bottom of the vehicle. The top wall 12b may extend horizontally from a top edge of the outer wall 12a toward the interior of the vehicle, and a top flange 12d may extend vertically upwards from an inner edge of the top wall 12b. The bottom wall 12c may extend horizontally from a bottom edge of the outer wall 12a toward the interior of the vehicle, and a bottom flange 12e may extend vertically downwards from an inner edge of the bottom wall 12c.

Referring to FIG. 1, the top flange 12d of the outer side sill 12 may be fixed to the top flange 11d of the inner side sill 11 using fasteners, welding, and/or the like, and the bottom flange 12e of the outer side sill 12 may be fixed to the bottom flange 11e of the inner side sill 11 using fasteners, welding, and/or the like. As the flanges 12d and 12e of the outer side sill 12 are fixed to the flanges 11d and 11e of the inner side sill 11, the outer side sill 12 may be joined to the inner side sill 11.

Referring to FIG. 1, the first reinforcement 21 and the second reinforcement 22 may be disposed in the cavity 13 defined between the inner side sill 11 and the outer side sill 12, and the first reinforcement 21 and the second reinforcement 22 may be aligned with the seat crossmember 3 in the width direction of the vehicle. The second reinforcement 22 may be fixed to the first reinforcement 21.

Referring to FIG. 1, the first reinforcement 21 may be fixed to the inner side sill 11, and the first reinforcement 21 may be spaced apart upward from the bottom wall 11c of the inner side sill 11. The first reinforcement 21 may have a rectangular frame shape cross section.

Referring to FIG. 1, the first reinforcement 21 may include an upper inner wall 41a and a lower inner wall 41b facing the interior of the vehicle, an upper outer wall 42a and a lower outer wall 42b facing the exterior of the vehicle, a top wall 43 facing the top of the vehicle, and a bottom wall 44 facing the bottom of the vehicle. A bottom edge of the upper inner wall 41a may be overlapped with and fixed to a top edge of the lower inner wall 41b, and a bottom edge of the upper outer wall 42a may be overlapped with and fixed to a top edge of the lower outer wall 42b. The top wall 43 and the bottom wall 44 may extend horizontally from the inner side sill 11 toward the outer side sill 12.

According to an example embodiment, the upper inner wall 41a of the first reinforcement 21 may be fixed to the inner wall 11a of the inner side sill 11 through a joint portion 31. The top wall 43 of the first reinforcement 21 may be fixed to the top wall 11b of the inner side sill 11 through a joint portion 32. Each of the joint portions 31 and 32 may be formed by any one of laser welding, high-frequency welding, CO₂ welding, and bolting.

Referring to FIG. 1, the first reinforcement 21 may further include an intermediate wall 45 horizontally extending between the top wall 43 and the bottom wall 44. The intermediate wall 45 may extend horizontally from the inner side sill 11 toward the outer side sill 12. The intermediate wall 45 may extend horizontally from the top edge of the lower inner wall 41b to the bottom edge of the upper outer wall 42a. The intermediate wall 45 may be located higher than the floor 2, and the bottom wall 44 may be located lower than the floor 2.

Referring to FIG. 1, the second reinforcement 22 may be fixed to the outer side sill 12, and the second reinforcement 22 may be spaced apart upward from the bottom wall 12c of the outer side sill 12. The second reinforcement 22 may have a trapezoidal frame shape cross section.

Referring to FIG. 1, the second reinforcement 22 may include an outer wall 51 facing the exterior of the vehicle, an inner wall 52 facing the interior of the vehicle, a top wall 53 facing the top of the vehicle, and a bottom wall 54 facing the bottom of the vehicle. A height of the outer wall 51 may be less than a height of the inner wall 52. The top wall 53 may extend from a top edge of the outer wall 51 to a top edge of the inner wall 52, and the top edge of the outer wall 51 may be lower than the top edge of the inner wall 52. The top wall 53 may be inclined downward from the top edge of the inner wall 52 toward the top edge of the outer wall 51.

The bottom wall 54 may extend from a bottom edge of the outer wall 51 to a bottom edge of the inner wall 52, and the bottom edge of the outer wall 51 may be higher than the bottom edge of the inner wall 52. The bottom wall 54 may be inclined upward from the bottom edge of the inner wall 52 toward the bottom edge of the outer wall 51.

According to an example embodiment, the outer wall 51 of the second reinforcement 22 may be fixed to the outer wall 12a of the outer side sill 12 through a joint portion 33. The joint portion 33 may be formed by any one of laser welding, high-frequency welding, CO₂ welding, and bolting.

Referring to FIG. 1, the second reinforcement 22 may further include a recessed wall 55 which is recessed from the inner wall 52 toward the outer wall 51. The recessed wall 55 may be horizontally aligned with the intermediate wall 45 of the first reinforcement 21.

Referring to FIG. 1, the side sill structure 100, according to example embodiments of the present disclosure, may include a support bracket 23 configured to support the first reinforcement 21 and the second reinforcement 22 within the side sill 10. The support bracket 23 may support the first reinforcement 21 and the second reinforcement 22 upward from the bottom wall 11c of the inner side sill 11 and the bottom wall 12c of the outer side sill 12. The support bracket 23 may have a top flange 23a horizontally extending from a top edge thereof toward the interior of the vehicle, and the top flange 23a of the support bracket 23 may be fixed to the bottom wall 44 of the first reinforcement 21. A bottom edge of the support bracket 23 may be interposed between the bottom flange 11e of the inner side sill 11 and the bottom flange 12e of the outer side sill 12, and the bottom edge of the support bracket 23 may be fixed to the bottom flange 11e of the inner side sill 11 and the bottom flange 12e of the outer side sill 12 using fasteners, welding, and/or the like. Accordingly, the first reinforcement 21 and the second reinforcement 22 may be spaced apart upward from the bottom wall 11c of the inner side sill 11 and the bottom wall 12c of the outer side sill 12 by the support bracket 23.

A cross-sectional area of the first reinforcement 21 may be larger than a cross-sectional area of the second reinforcement 22. Referring to FIG. 1, the first reinforcement 21 and the second reinforcement 22 may be horizontally aligned with the floor 2 and the seat crossmember 3. Accordingly, in the event of a side collision/impact of the vehicle, the first reinforcement 21 and the second reinforcement 22 may absorb impact energy to resist the impact energy.

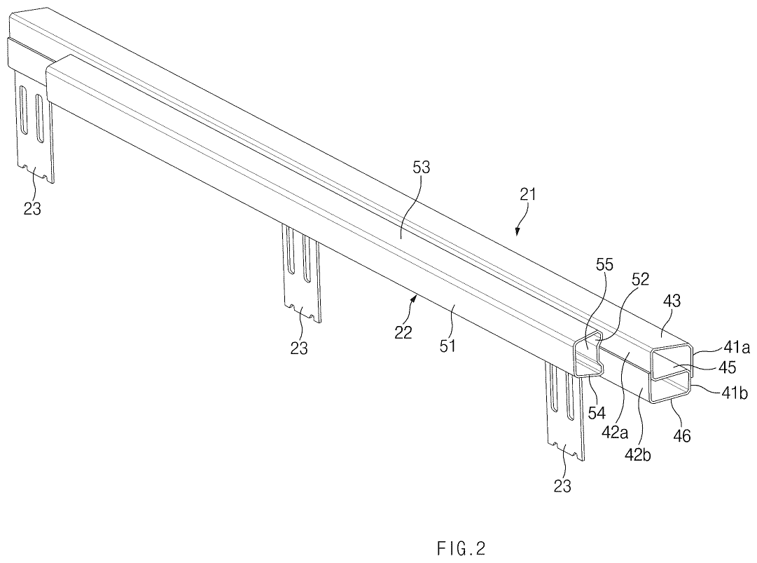

Referring to FIG. 2, the first reinforcement 21 and the second reinforcement 22 may extend in the longitudinal direction of the vehicle, and the first reinforcement 21 may be fixed to the second reinforcement 22. The plurality of support brackets 23 may be spaced apart from each other in a longitudinal direction of the first reinforcement 21 and a longitudinal direction of the second reinforcement 22.

Referring to FIG. 1, the cross-sectional area of the first reinforcement 21 may be larger than the cross-sectional area of the second reinforcement 22, and the first reinforcement 21 may horizontally support the second reinforcement 22 by the top wall 43, the bottom wall 44, and the intermediate wall 45 so that deformation of the first reinforcement 21 by the impact energy may be suppressed in the event of a side collision/impact of the vehicle. That is, the first reinforcement 21 may form a region A1, which provides resistance to deformation due to the impact energy, within the inner side sill 11.

Referring to FIG. 1, the cross-sectional area of the second reinforcement 22 may be smaller than the cross-sectional area of the first reinforcement 21, and the second reinforcement 22 may have the recessed wall 55 so that deformation of the second reinforcement 22 by the impact energy may be induced in the event of a side collision/impact of the vehicle. That is, the second reinforcement 22 may form a region A2, which can induce deformation due to the impact energy, within the inner side sill 11.

According to an example embodiment, the first reinforcement 21 and the second reinforcement 22 may be made of a steel material. Specifically, the first reinforcement 21 and the second reinforcement 22 may be made of a cold rolled steel sheet. For example, the first reinforcement 21 and the second reinforcement 22 may be manufactured by roll foaming. As the first reinforcement 21 and the second reinforcement 22 are made of a steel material, the manufacturing cost and weight thereof may be significantly reduced compared to a reinforcement according to the related art made of an aluminum extruded product.

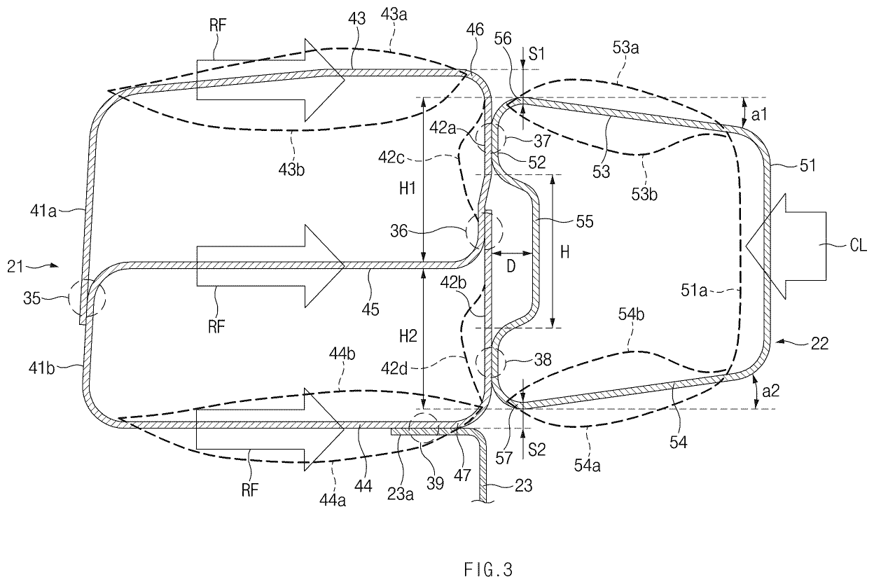

Referring to FIG. 3, the bottom edge of the upper inner wall 41a may be overlapped with and fixed to the top edge of the lower inner wall 41b through a joint portion 35. The top edge of the lower outer wall 42b may be overlapped with and fixed to the bottom edge of the upper outer wall 42a through a joint portion 36. An upper portion of the inner wall 52 of the second reinforcement 22 may be overlapped with and fixed to the upper outer wall 42a of the first reinforcement 21 through a joint portion 37. A lower portion of the inner wall 52 of the second reinforcement 22 may be overlapped with and fixed to the lower outer wall 42b of the first reinforcement 21 through a joint portion 38. The top flange 23a of the support bracket 23 may be overlapped with and fixed to the bottom wall 44 of the first reinforcement 21 through a joint portion 39. Each of the joint portions 35, 36, 37, 38, and 39 may be formed by any one of laser welding, high-frequency welding, CO₂ welding, and bolting.

Referring to FIG. 3, the top wall 53 of the second reinforcement 22 may be located lower than the top wall 43 of the first reinforcement 21. A top edge 56 of the inner wall 52 of the second reinforcement 22 may be located lower than a top edge 46 of the upper outer wall 42a of the first reinforcement 21 by a predetermined height S1. The top edge of the outer wall 51 may be located lower than the top edge of the inner wall 52, and the top wall 53 may be inclined downward from the inner wall 52 toward the outer wall 51 at a first angle a1.

Referring to FIG. 3, the bottom wall 54 of the second reinforcement 22 may be located higher than the bottom wall 44 of the first reinforcement 21. A bottom edge 57 of the inner wall 52 of the second reinforcement 22 may be located higher than a bottom edge 47 of the lower outer wall 42b of the first reinforcement 21 by a predetermined height S2. The bottom edge of the outer wall 51 may be located higher than the bottom edge of the inner wall 52, and the bottom wall 54 may be inclined upward from the inner wall 52 toward the outer wall 51 at a second angle a2.

Referring to FIG. 3, the intermediate wall 45 of the first reinforcement 21 may be located in a range of the recessed wall 55 of the second reinforcement 22. Referring to FIG. 3, the top edge 56 of the inner wall 52 of the second reinforcement 22 may be located higher than the intermediate wall 45 of the first reinforcement 21 by a first height H1, and the bottom edge 57 of the inner wall 52 of the second reinforcement 22 may be located lower than the intermediate wall 45 of the first reinforcement 21 by a second height H2. The first height H1 and the second height H2 may be varied.

Referring to FIG. 3, the recessed wall 55 of the second reinforcement 22 may be recessed from the inner wall 52 toward the outer wall 51 by a predetermined depth D, and the recessed wall 55 of the second reinforcement 22 may have a predetermined height H. The depth D and the height H may be varied.

Referring to FIG. 3, in the event of a side collision/impact of the vehicle, when an impact load CL is transferred to the second reinforcement 22, the outer wall 51 of the second reinforcement 22 may be deformed toward the interior of the vehicle (see a dotted line 51a of FIG. 3), the top wall 53 of the second reinforcement 22 may be deformed convexly upward by the recessed wall 55 (see a dotted line 53a of FIG. 3) or be deformed concavely downward by the recessed wall 55 (see a dotted line 53b of FIG. 3), and the bottom wall 54 of the second reinforcement 22 may be deformed convexly downward by the recessed wall 55 (see a dotted line 54a of FIG. 3) or be deformed concavely upward by the recessed wall 55 (see a dotted line 54b of FIG. 3).

Referring to FIG. 3, when the impact load CL is transferred to the first reinforcement 21 through the second reinforcement 22, reaction loads RF may be applied to the second reinforcement 22 through the top wall 43, the bottom wall 44, and the intermediate wall 45 of the first reinforcement 21. Accordingly, the top wall 43 of the first reinforcement 21 may be deformed convexly upward by the recessed wall 55 of the second reinforcement 22 (see a dotted line 43a of FIG. 3) or be deformed concavely downward by the recessed wall 55 of the second reinforcement 22 (see a dotted line 43b of FIG. 3), the bottom wall 44 of the first reinforcement 21 may be deformed convexly downward by the recessed wall 55 of the second reinforcement 22 (see a dotted line 44a of FIG. 3) or be deformed concavely upward by the recessed wall 55 of the second reinforcement 22 (see a dotted line 44b of FIG. 3), the upper outer wall 42a of the first reinforcement 21 may be deformed concavely toward the interior of the vehicle by the recessed wall 55 of the second reinforcement 22 (see a dotted line 42c of FIG. 3), and the lower outer wall 42b of the first reinforcement 21 may be deformed concavely toward the interior of the vehicle by the recessed wall 55 of the second reinforcement 22 (see a dotted line 42d of FIG. 3).

During a side collision/impact of the vehicle, the first reinforcement 21 and the second reinforcement 22 may be deformed by the recessed wall 55 so that the rotation of the first reinforcement 21 and the second reinforcement 22 may be prevented. As the impact energy is transferred to the second reinforcement 22 and the first reinforcement 21, the deformation of the second reinforcement 22 may be induced by the recessed wall 55, and the deformation of the first reinforcement 21 may be suppressed by the top wall 43, the bottom wall 44, and the intermediate wall 45.

As set forth above, a vehicle side sill structure, according to example embodiments of the present disclosure, may be designed to allow a first reinforcement to horizontally support a second reinforcement due to a top wall, a bottom wall, and an intermediate wall of the first reinforcement so that the deformation of the first reinforcement by an impact energy may be suppressed in the event of a side collision/impact of the vehicle. The second reinforcement may have a recessed wall so that the deformation of the second reinforcement by the impact energy may be induced in the event of a side collision/impact of the vehicle.

According to example embodiments of the present disclosure, if the first reinforcement and the second reinforcement are made of a steel material, the manufacturing cost and weight thereof may be significantly reduced compared to the related art reinforcement made of an aluminum extruded product.

Hereinabove, although the present disclosure has been described with reference to example embodiments and the accompanying drawings, the present disclosure is not necessarily limited thereto, and may be variously modified and altered by those skilled in the art to which the present disclosure pertains without departing from the spirit and scopes of the present disclosure claimed in the following claims and/or equivalents thereof.

What is claimed is:

1. A vehicle side sill structure, comprising:
an inner side sill fixed to a floor of a vehicle;
an outer side sill joined to the inner side sill; and
a first reinforcement and a second reinforcement disposed in a cavity defined between the inner side sill and the outer side sill, wherein the first reinforcement is fixed to the inner side sill, and wherein the second reinforcement is fixed to the outer side sill.

2. The structure according to claim 1, wherein the second reinforcement is fixed to the first reinforcement.

3. The structure according to claim 1, wherein the first reinforcement has a rectangular frame cross-section shape.

4. The structure according to claim 1, wherein the first reinforcement comprises:
a top wall facing a top of the vehicle; and
a bottom wall facing a bottom of the vehicle, wherein the top wall and the bottom wall extend horizontally from the inner side sill toward the outer side sill.

5. The structure according to claim 4, wherein the first reinforcement further comprises an intermediate wall extending horizontally between the top wall and the bottom wall.

6. The structure according to claim 1, wherein the first reinforcement comprises:
an upper inner wall and a lower inner wall facing an interior of the vehicle; and
an upper outer wall and a lower outer wall facing an exterior of the vehicle, wherein a first bottom edge of the upper inner wall is overlapped with and fixed to a first top edge of the lower inner wall, and wherein a second bottom edge of the upper outer wall is overlapped with and fixed to a second top edge of the lower outer wall.

7. The structure according to claim 1, wherein the second reinforcement has a trapezoidal frame cross-section shape.

8. The structure according to claim 1, wherein the second reinforcement comprises:
an outer wall facing an exterior of the vehicle;
an inner wall facing an interior of the vehicle;
a first top wall extending from a first top edge of the outer wall to a second top edge of the inner wall; and
a first bottom wall extending from a first bottom edge of the outer wall to a second bottom edge of the inner wall.

9. The structure according to claim 8, wherein the first top wall is inclined downward from the second top edge of the inner wall toward the first top edge of the outer wall, and
wherein the first bottom wall is inclined upward from the second bottom edge of the inner wall toward the first bottom edge of the outer wall.

10. The structure according to claim 8, wherein the second reinforcement further comprises a recessed wall that is recessed from the inner wall toward the outer wall.

11. The structure according to claim 10, wherein the first reinforcement comprises:
a second top wall;
a second bottom wall; and
an intermediate wall located between the second top wall and the second bottom wall, wherein the intermediate wall of the first reinforcement is aligned with the recessed wall of the second reinforcement.

12. The structure according to claim 11, wherein the first top wall of the second reinforcement is located lower than the second top wall of the first reinforcement, and
wherein the first bottom wall of the second reinforcement is located higher than the second bottom wall of the first reinforcement.

13. The structure according to claim 1, further comprising a support bracket configured to support the first reinforcement and the second reinforcement.

14. The structure according to claim 13, wherein the support bracket has a top flange fixed to the first reinforcement.

15. The structure according to claim 1, wherein a first cross-sectional area of the first reinforcement is larger than a second cross-sectional area of the second reinforcement.

16. The structure according to claim 1, wherein a first width of the first reinforcement is larger than a second width of the second reinforcement.

17. An electric vehicle comprising:
a floor;
a battery assembly having a battery case, wherein the battery assembly is located below the floor;
vehicle side sill structure comprising:
an inner side sill attached to the floor, wherein the battery case is attached to the inner side sill;
an outer side sill joined to the inner side sill; and
a first reinforcement and a second reinforcement disposed in a cavity defined between the inner side sill and the outer side sill, wherein the first reinforcement is fixed to the inner side sill, and wherein the second reinforcement is fixed to the outer side sill.

18. The vehicle according to claim 17, wherein the first reinforcement has a generally rectangular frame cross-section shape;
wherein the second reinforcement has a generally trapezoidal frame cross-section shape;
wherein the first reinforcement comprises:
a first top wall facing a top of the vehicle, and
a first bottom wall facing a bottom of the vehicle, wherein the first top wall and the first bottom wall extend horizontally from the inner side sill toward the outer side sill,
an intermediate wall extending horizontally between the first top wall and the first bottom wall,
an upper inner wall facing an interior of the vehicle,
a lower inner wall facing the interior of the vehicle, wherein a first bottom edge of the upper inner wall is overlapped with and a first top edge of the lower inner wall,
an upper outer wall facing an exterior of the vehicle, and
a lower outer wall facing the exterior of the vehicle, wherein a second bottom edge of the upper outer wall is overlapped with and a second top edge of the lower outer wall; and
wherein the second reinforcement comprises:
a main outer wall facing the exterior of the vehicle,
a main inner wall facing the interior of the vehicle,
a second top wall is inclined downward extending from the main outer wall to the main inner wall,
a second bottom wall is inclined upward extending from the main outer wall to the main inner wall, and
a recessed wall that is recessed from the main inner wall toward the main outer wall, wherein the intermediate wall of the first reinforcement is aligned with the recessed wall of the second reinforcement, wherein the second top wall of the second reinforcement is located lower than the first top wall of the first reinforcement, and wherein the second bottom wall of the second reinforcement is located higher than the first bottom wall of the first reinforcement.

19. The vehicle according to claim 18, further comprising a support bracket configured to support the first reinforcement.

20. The vehicle according to claim 18, wherein the upper inner wall extends from the first top wall,
wherein the lower inner wall extends from the intermediate wall,
wherein the upper outer wall extends from the first top wall,
wherein the lower outer wall extends from the first bottom wall,
wherein a first cross-sectional area of the first reinforcement is larger than a second cross-sectional area of the second reinforcement, and
wherein a first width of the first reinforcement is larger than a second width of the second reinforcement.
